(19) United States
(12) Patent Application Publication
(10) Pub. No.: US 2006/0190675 A1
(43) Pub. Date: Aug. 24, 2006

(54) Control apparatus

(75) Inventor: Eiji Otsuka, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/339,524

(22) Filed: Jan. 26, 2006

(30) Foreign Application Priority Data
Jan. 27, 2005 (JP) P2005-019056

(51) Int. Cl. G06F 12/00; G06F 12/14

(52) U.S. Cl. 711/104; 711/152

(57) ABSTRACT

A control apparatus includes an RAM capable of rewriting data; a data writing unit that writes a predetermined length of data output to the RAM in an arbitrary area of the RAM on the basis of an address signal for designating an address of the RAM and an effective area definition signal for defining an area effective in writing the predetermined length of data into the RAM; a judgment unit that judges whether the writing of the predetermined length of data into the RAM by the data writing unit is to be prohibited or not; and a rewriting prohibition unit that changes the effective area definition signal to a signal invalidating the writing of the whole predetermined length of data when the judgment unit makes a decision that the writing is to be prohibited.

### CROSS-REFERENCE TO RELATED APPLICATION

This application is based on and claims the benefit of priority from the prior Japanese Patent Application No. 2005-19056, filed on Jan. 27, 2005; the entire contents of which are incorporated herein by reference.

### BACKGROUND

1. Technical Field

The present invention relates to a control apparatus equipped with an RAM (Random Access Memory).

2. Description of Related Art

Because DRAM (Dynamic Random Access Memory) is generally quickly accessible and low in unit cost per bit compared with ROM (Read Only Memory), there has been popularized a method in which an operating program to be executed by a CPU (Central Processing Unit) is compressed and stored in an ROM in advance so that the operating program can be executed in a DRAM after the operating program is expanded and transferred to the DRAM. There is however a possibility that an area of storage of the operating program will be rewritten by mistake to cause a runaway of the CPU because the DRAM is a rewritable memory.

Therefore, there has been proposed a method in which the CPU judges whether an address used for writing data into the DRAM is in a program area or not, and in which the CPU suppresses the writing of data into the program area by inactivating a write signal determining whether the writing of data is to be performed or not, when the CPU makes a decision that the address is in the program area (e.g. see JP-A-11-96075).

### SUMMARY

For example, SDRAM (Synchronous DRAM) is however controlled by an input command composed of a combination of a write signal and another signal (such as an RAS signal, a CAS signal, etc). That is, although the write signal is active, there is some case where data is written in the SDRAM and there is some case where another command without data writing (e.g. a refresh command for refreshing storage elements of the SDRAM cyclically) is input to the SDRAM. If the write signal is forcedly inactivated as in the method according to JP-A-11-96075, several commands cannot be input to the SDRAM though the writing of data can be prohibited.

The present invention has been made in view of the above circumstances and provides a control apparatus in which RAM control commands are not restrained from being input while a wrong operation of the CPU is prevented from being caused by the rewriting of the operating program in the RAM.

According to an aspect of the invention, a control apparatus includes an RAM capable of rewriting data; a data writing unit that writes a predetermined length of data output to the RAM in an arbitrary area of the RAM on the basis of an address signal for designating an address of the RAM and an effective area definition signal for defining an area effective in writing the predetermined length of data into the RAM; a judgment unit that judges whether the writing of the predetermined length of data into the RAM by the data writing unit is to be prohibited or not; and a rewriting prohibition unit that changes the effective area definition signal to a signal invalidating the writing of the whole predetermined length of data when the judgment unit makes a decision that the writing is to be prohibited.

### BRIEF DESCRIPTION OF THE DRAWINGS

These and other objects and advantages of this invention will become more fully apparent from the following detailed description taken with the accompanying drawings in which:

FIG. 1 is a block diagram showing the configuration of a telephone exchange according to an embodiment;

FIG. 2 is a block diagram showing the configuration of a control portion in the embodiment;

FIG. 3 is a block diagram showing the configuration of an SDRAM according to the embodiment;

FIG. 4 is a diagram showing a specific example of a circuit concerned with the SDRAM in the control portion according to the embodiment;

FIG. 5 is a table showing an example of commands input to the SDRAM in the control portion according to the embodiment;

FIG. 6 is a timing chart showing an example of signals concerned with a write cycle operation of the control portion according to the embodiment;

FIG. 7 is a flow chart showing a flow of processing in a comparison circuit in the control portion according to the embodiment;

FIG. 8 is a table showing the relation between signals concerned with a gate circuit in the control portion according to the embodiment;

FIG. 9 is a timing chart showing an example of signals input to the SDRAM in a write cycle in the case where write protection is performed by the gate circuit in the control portion according to the embodiment; and

FIG. 10 is a diagram showing a specific example of a circuit concerned with the SDRAM in the control portion in another embodiment.

### DESCRIPTION OF THE EMBODIMENTS

A control apparatus of embodiments will be described below with reference to the drawings.

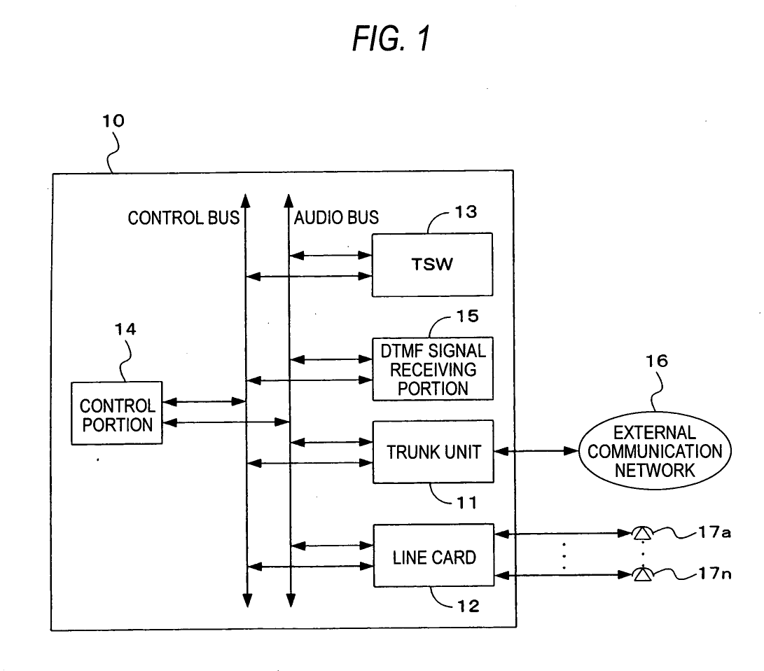

FIG. 1 is a diagram showing the configuration of a telephone exchange which is an information processor as an embodiment. The telephone exchange 10 includes a trunk unit 11, a line card 12, a time switch portion (TSW) 13, a control portion 14, and a DTMF (Dial Tone Multi Frequency) signal receiving portion 15. These constituent members are connected to one another through an audio bus and a control bus.

The trunk unit 11 is connected to an external communication network 16. The trunk unit 11 has an interface function with the external communication network 16. The line card 12 is provided so that private branch terminals 17a to 17n are connected. The line card 12 has an interface function with the private branch terminals 17a to 17n. Incidentally, for example, a standard telephone set, a button telephone set, etc. can be used as the private branch terminals 17a to 17n.

The TSW 13 exchangeably connects the trunk unit 11 and the line card 12 to each other in accordance with an instruction given by the control portion 14. The TSW 13 exchangeably connects the trunk unit 11, the line card 12 and the DTMF signal receiving portion 15 to one another in the same manner as described above.

The control portion 14 has a CPU (Central Processing Unit), a memory, etc. The control portion 14 generally controls the operation of the telephone exchange 10 as a whole. The CPU, the memory, etc. included in the control portion 14 are mounted on one board. The details of the control portion 14 will be described later.

The DTMF signal receiving portion 15 performs a digital filter process such as DFT (Discrete Fourier Transform) on a digital signal to thereby detect and identify a DTMF signal. Incidentally, the DTMF signal is a signal which corresponds to a dial key and which is output from the private branch terminals 17a to 17n.

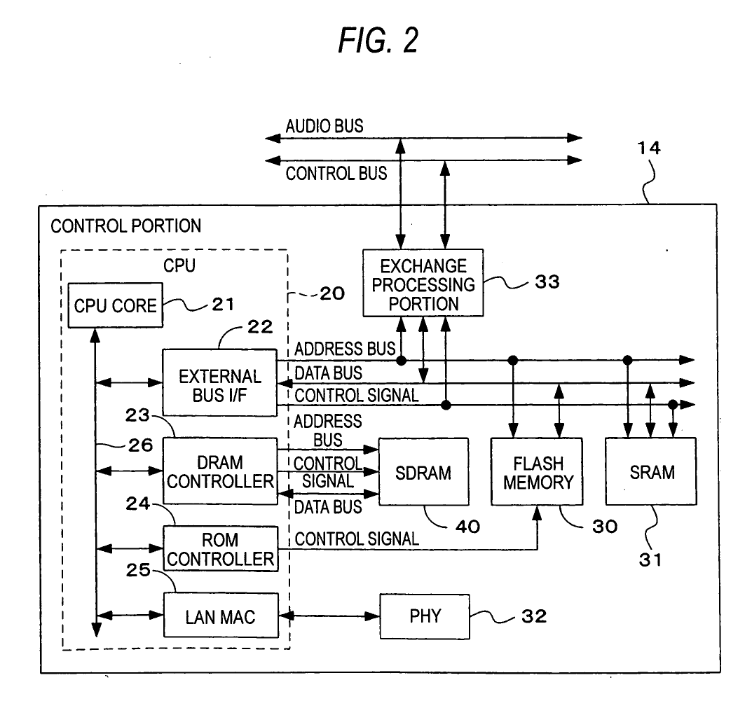

FIG. 2 is a diagram showing the schematic configuration of the control portion 14 in the telephone exchange 10. Incidentally, a comparison circuit, a protection register, etc. which will be described later are not shown in FIG. 2. The control portion 14 has a CPU 20 (data writing unit), a flash memory 30 in which a compressed operating program is stored, an SRAM (Static Random Access Memory) 31 as a general-purpose memory, a PHY 32 as an LAN (Local Area Network) interface, an exchange processing portion 33 playing the role of an interface with the audio bus and the control bus, and an SDRAM 40 (RAM) in which the operating program stored in the flash memory 30 is expanded and stored and in which data can be written.

The CPU 20 executes the operating program stored in the SDRAM 40 and generally controls the operation of the telephone exchange 10 as a whole. Incidentally, the CPU 20 processes data for every 32 bits (data width). The CPU 20 has a CPU core 21 for executing a process based on an instruction fetched from the SDRAM 40, an external bus interface 22 as an interface with the flash memory 30, the SRAM 31 and the exchange processing portion 33, a DRAM controller 23 for controlling the SDRAM 40, an ROM controller 24 for controlling the flash memory 30, and an LAN MAC (LAN Media Access Controller) 25 as an interface with the PHY 32. The CPU core 21, the external bus interface 22, the DRAM controller 23, the ROM controller 24 and the LAN MAC 25 are connected to an internal bus 26 independently.

The external bus interface 22 is an interface with the flash memory 30, the SDRAM 31 and the exchange processing portion 33. The external bus interface 22 is connected to an address bus and a data bus. An address is designated through the address bus to thereby designate the position of data to be accessed. Data are exchanged between the flash memory 30, the SRAM 31 and the exchange processing portion 33 by the data bus. A control signal for the SRAM 31 and the exchange processing portion 33 is also output from the external bus interface 22. In this specification, the term “control signal” means a signal such as a read signal for reading data, a write signal for writing data or a chip select signal for selecting a chip.

The DRAM controller 23 controls the SDRAM 40 by outputting a control signal. An address signal for accessing the SDRAM 40 is also output from the DRAM controller 23 to the SDRAM, so that the DRAM controller 23 plays the role of an interface for inputting/outputting data to/from the SDRAM 40 through the data bus.

The ROM controller 24 controls the flash memory 30 by outputting a control signal to the flash memory 30.

The LAN MAC 25 plays the role of an interface with the PHY 32 as an LAN communication interface for performing waveform generation, collision detection, etc. with respect to communication. The LAN MAC 25 performs decision of the transmitting/receiving method in the LAN communication, error correction, etc.

The operating program to be fetched by the CPU core 21 is compressed and stored in the flash memory 30. When the CPU 20 is to read the compressed operating program, the CPU 20 receives the designated program storage address from the external bus interface 22 through the address bus at the same time the CPU 20 operates, so that the CPU 20 receives the program output through the data bus connected to the same external bus interface 22. A control signal for controlling this operation is accepted from the ROM controller 24.

The exchange processing portion 33 plays the role of an interface of the control portion 14 with the audio bus and the control bus. The trunk unit 11, the line card 12, the TSW 13 and the DTMF signal receiving portion 15 are connected to the exchange processing portion 33 through the audio bus and the control bus. The exchange processing portion is further connected to the external bus interface 22 of the CPU 20 through the address bus and the data bus. The exchange processing portion 33 accepts a control signal from the external bus interface 22.

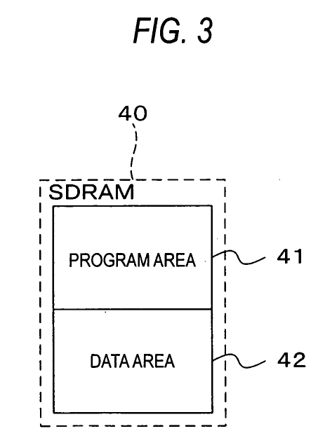

The SDRAM 40 is provided so that not only the program can be stored in the SDRAM 40 but also general data can be written in the SDRAM 40. FIG. 3 is a diagram showing the configuration of the SDRAM 40. As shown in FIG. 3, the SDRAM 40 has a program area 41 (unrewritable area), and a data area 42. The compressed operating program stored in the flash memory 30 is expanded by the CPU 20 and stored in the program area 41. The data area 42 is an area which is used as a work memory when the CPU 20 executes the operating program. Addresses of the program area 41 and the data area 42 are stored in a comparison circuit (judgment unit) (which will be described later) in advance.

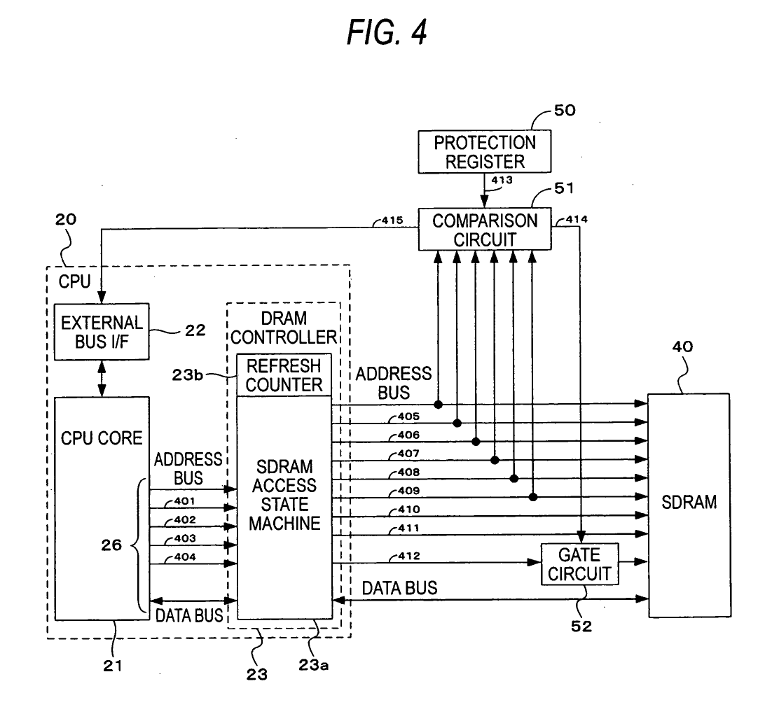

FIG. 4 is a diagram showing a specific example of a circuit concerned with the SDRAM 40 in the control portion 14 depicted in FIG. 2. This circuit has a CPU 20, an SDRAM 40, a protection register 50 (write protection setting unit) for controlling whether the program area 41 of the SDRAM 40 should be subjected to write protection or not, a comparison circuit 51 (judgment unit) for comparing the write address etc. of the SDRAM 40, and a gate circuit 52 (rewriting prohibition unit) for prohibiting writing in accordance with a result given from the comparison circuit. Incidentally, the ROM controller 24 and the LAN MAC 25 in the CPU 20, the flash memory 30, the SRAM 31, the PHY 32 and the exchange processing portion 33 shown in FIG. 2 in the control circuit 14 are not shown in FIG. 4.

The DRAM controller 23 in the CPU 20 has an SDRAM access state machine 23a, and a refresh counter 23b. The SDRAM access state machine 23a is an interface for inputting/outputting data by controlling the SDRAM 40. The refresh counter 23b is a counter for performing refreshing for every specific time (e.g. 16 μs) by designating a bank of the SDRAM 40.

The CPU core 21 and the SDRAM access state machine 23a are connected to each other through the internal bus 26. The internal bus 26 includes an address bus for designating an address used for accessing the SDRAM 40, and a data bus for exchanging data input/output to/from the SDRAM 40. The CPU core 21 further outputs a control signal for the SDRAM 40 to the SDRAM access state machine 23a. The details of the control signal will be described below.

In the example shown in FIG. 4, the control signal includes a CS signal 401, an RD signal 402, a WE signal 403, and a BE signal 404. The CS signal 401 is a signal for deciding whether the SDRAM 40 is selected or not. The CS signal 401 becomes active when the CPU 20 makes access to the SDRAM 40. The RD signal 402 becomes active when data is read from the SDRAM 40. The WE signal 403 becomes active when data is written in the SDRAM 40.

The BE signal 404 is a signal for selecting an effective byte from 32 bits as a unit of processing. Because the BE signal 404 is a signal the 32-bit bus is divided by byte (8 bits), the quantity of information in the BE signal 404 is 32/8 bits, that is, 4 bits. When, for example, only one upper byte is valid, the BE signal 404 is formed so that one bit corresponding to the upper byte becomes active while three bits corresponding to the residual three bytes become inactive.

Upon reception of a signal from the CPU core 21, the SDRAM access state machine 23a outputs a signal to the SDRAM 40. The SDRAM 40 and the SDRAM access state machine 23a are connected to each other by the address bus for exchanging the address signal for designating the access address and the data bus for exchanging data. The SDRAM access state machine 23a also outputs a control signal for controlling the SDRAM 40. In the example shown in FIG. 4, this control signal includes a CAS signal 405, an RAS signal 406, a WE signal 407, an MCS signal 408, a BA signal 409, a CLK signal 410, a CKE signal 411, and a DQMB signal 412 (effective area definition signal).

The CLK signal 410 is a clock signal for operating the SDRAM 40. All input signals and data input/output signals in the SDRAM 40 are synchronized with the leading edge of the CLK signal 410. The CKE signal 411 is a signal for deciding whether the CLK signal 410 is valid or not. When the level of the CKE signal 411 is high at the leading edge of a certain CLK signal, the leading edge of a next CLK signal 410 becomes valid.

The BA signal 409 is a signal for designating a bank of the SDRAM 40 to be accessed. When, for example, the SDRAM 40 has four banks, the quantity of information in the BA signal 409 is 2 bits.

The MCS signal 408 is a signal for deciding whether the SDRAM 40 is selected or not. When the MCS signal 408 is active, a command can be input to the SDRAM 40.

The DQMB signal 412 can designate an area validated when, for example, 32-bit data is output. When the quantity of information in the DQMB signal 412 is 2 bits, the DQMB signal 412 can decide which half of 32 bits used is valid, upper 16 bits or lower 16 bits. When, for example, the DQMB signal 412 corresponding to the upper 16 bits is active, the upper 16 bits become invalid. Incidentally, the DQMB signal 412 is a signal in response to the BE signal 404 input from the CPU core 21 to the SDRAM access state machine 23a. When, for example, the quantity of information in the DQMB signal 412 is 4 bits, the BE signal 404 can be directly used as the DQMB signal 412 because the quantity of information in the DQMB signal 412 is equal to the quantity of information in the BE signal 404. Description will be made below upon the assumption that the DQMB signal 412 is a 2-bit signal.

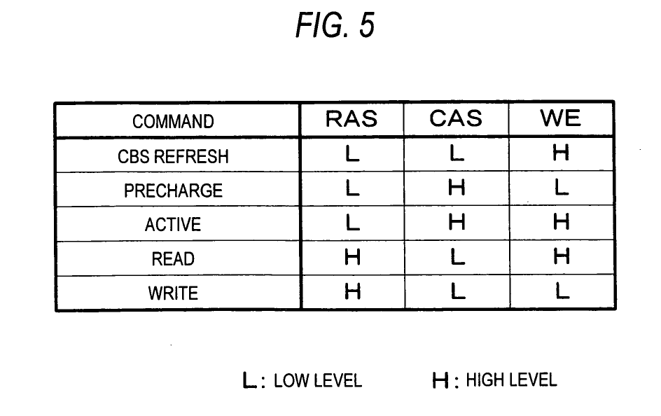

The CAS signal 405, the RAS signal 406 and the WE signal 407 are used for inputting a command. FIG. 5 shows an example of commands input to the SDRAM 40 by use of the CAS signal 405, the RAS signal 406 and the WE signal 407. Incidentally, in this example, the level of the CKE signal 411 is low (active) and the level of the MCS signal 408 is low (active).

The CBR refresh command is a command for refreshing storage elements for every predetermined time in accordance with the timing of the refresh counter 23b. After the CBR refresh command is input, all commands are disabled from being accepted unless a predetermined time passes. The CBR refresh command is input to the SDRAM 40 in the condition that the levels of the RAS signal 406 and the CAS signal 405 are low while the level of the WE signal 407 is high.

The precharge command is a command for starting a precharge operation of the selected bank of the SDRAM 40. The term “precharge” means an operation for charging the storage elements at the time of data reading. The precharge command is input to the SDRAM 40 in the condition that the levels of the RAS signal 406 and the WE signal 407 are low while the level of the CAS signal 405 is high.

The active command is a command for latching a row address of the bank selected by the BA signal. The row address is selected on the basis of the address signal when the active command is input. The active command is input to the SDRAM 40 in the condition that the level of the RAS signal 406 is low while the levels of the CAS signal 405 and the WE signal 407 are high.

The read command is a command for starting a read operation and latching a column address. The column address is selected on the basis of the address signal when the read command is input. That is, when the read command is input to the SDRAM 40 after the active command is input, the SDRAM access state machine 23a can read data from the selected address through the data bus. The read command is input to the SDRAM 40 in the condition that the levels of the RAS signal 406 and the WE signal 407 are high while the level of the CAS signal 405 is low.

The write command is a command for starting a write operation and latching a column address. The column address is selected on the basis of the address signal when the write command is input. That is, when the write command is input to the SDRAM 40 after the active command is input, the SDRAM access state machine 23a can write data into the selected address through the data bus. The write command is input to the SDRAM 40 in the condition that the level of the RAS signal 406 is high while the levels of the CAS signal 405 and the WE signal 407 are low.

When the control signal configured as described above is output to the SDRAM 40, the SDRAM access state machine 23a controls the SDRAM 40.

Referring back to FIG. 4, the protection register 50 is a register for setting whether the SDRAM 40 should be subjected to write protection or not. When, for example, the compressed operating program stored in the flash memory 30 is expanded by the CPU 20 and written into the SDRAM 40, write protection is not required. After the program is written into the SDRAM 40, write protection is however required because there is a possibility that overwriting of the program in the SDRAM 40 will cause a runaway of the program. The protection register 50 switches this operation by outputting a write protection signal 413 (WP signal) to the comparison circuit 51.

When a decision is made that write protection is performed by control of the protection register 50, that is, when the WP signal 413 is active, the comparison circuit 51 refers to the address signal, the CAS signal 405, the RAS signal 406, the WE signal 407, the MCS signal 408 and the BA signal 409 to thereby judge whether data is to be written into the SDRAM 40 or not. The comparison circuit 51 outputs a result of the judgment as a WPACC signal to the gate circuit. The result of the judgment as to whether data is to be written or not, is also output as an NMI signal 415 (notice signal) to the external bus interface of the CPU 20. The NMI signal 415 is used for writing data into the program area 41, that is, for holding history information to debug errors of the program or recovering software abnormality. For writing without write protection such as transferring of the program to the SDRAM 40, the comparison circuit 51 cooperates with the protection register 50 so that the NMI signal 415 is not generated. The gate circuit 52 controls the DQMB signal 412 on the basis of the comparison circuit's judgment as to whether write protection is required or not. The operations of the comparison circuit 51 and the gate circuit 52 will be described later in detail.

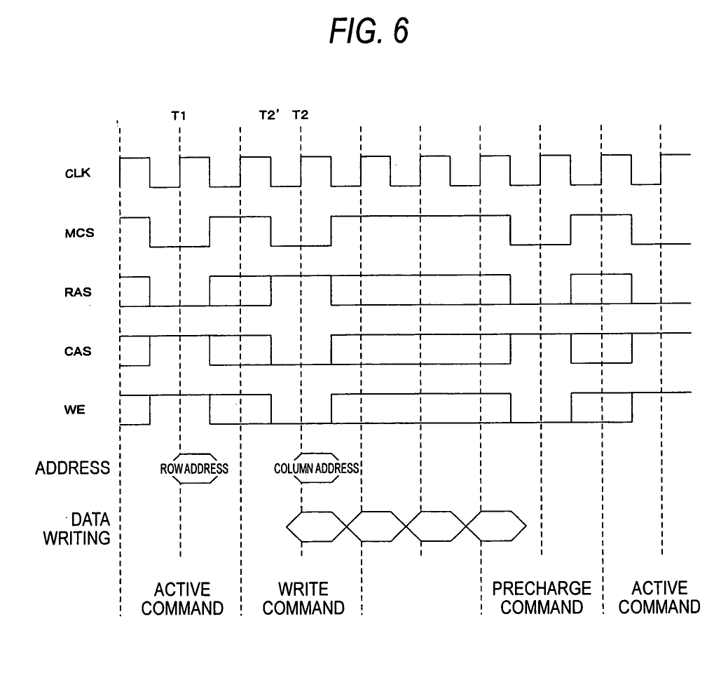

Next, an ordinary write operation into the SDRAM 40 by the SDRAM access state machine 23a will be described. In the following description, write protection is not performed. FIG. 6 is a timing chart of a write cycle operation. At time T1, an active command is input as shown in the table of FIG. 5 because the level of the MCS signal 408 is low (active) and the level of the RAS signal 406 is low while the levels of the CAS signal 405 and the WE signal 407 are high. Accordingly, a row address and a bank are decided on the basis of the address signal and the BA signal 409 respectively.

At time T2 following T1, a write command is input as shown in the table of FIG. 5 because the level of the MCS signal 408 is low (active) and the level of the RAS signal 406 is high while the levels of the CAS signal 405 and the WE signal 407 are low. Accordingly, a column address and a bank are acquired from the address signal and the BA signal 409 respectively.

A write address is decided on the basis of the bank, the row address and the column address acquired at T1 and T2, so that data input from the SDRAM access state machine 23a through the data bus is written. In the example shown in FIG. 6, the burst length of data is 4 each having an information quantity of 32 bits. For example, to invalidate upper 16 bits as an upper half of the 32 bits, the SDRAM access state machine 23a can make the level of the DQMB signal 412 corresponding to the upper 16 bits low (active).

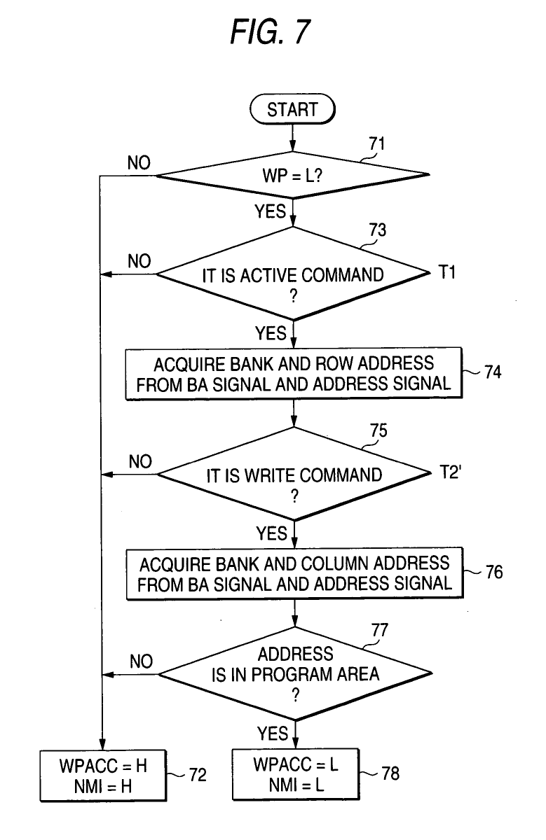

Next, the operation of the comparison circuit 51 will be described with reference to FIG. 7. FIG. 7 is a flow chart showing a flow of processing in the comparison circuit 51. First, the comparison circuit 51 judges whether the level of the WP signal 413 input from the protection register 50 is low (active) or not (step 71). When the level of the WP signal 413 is high (inactive), the comparison circuit 51 makes a decision that write protection is not required, and makes the level of the WPACC signal 414 output to the gate circuit high (inactive) (step 72). At the same time, the comparison circuit 51 makes the level of the NMI signal 415 output to the external bus interface 22 of the CPU 20 high (inactive).

Then, the comparison circuit 51 judges whether the active command is input to the SDRAM 40 or not (step 73, at time T1 in FIG. 6). This judgment is made on the basis of the fact that the levels of the MCS signal 408 and the RAS signal 406 are low while the levels of the CAS signal 405 and the WE signal 407 are high. In this condition, a decision can be made that the active command is input to the SDRAM 40. If there is no active command (No in step 73), the WPACC signal 414 with the level turned to a high level (inactive) is output to the gate circuit while the NMI signal 415 with the level turned to a high level (inactive) is output to the external bus interface 22 (step 72) because write protection is not particularly required. If there is the active command in the step 73 (Yes in step 73), a bank and a row address are acquired from the BA signal 409 and the address signal respectively (step 74).

The comparison circuit 51 further judges whether the command input next to the active command is a write command or not (step 75). In the example shown in FIG. 6, this judgment is made in a period of from falling time (T2′) of the CLK signal 410 just before time T2 to time T2. If there is no write command (No in step 75), that is, unless the level of the MCS signal 408 is low and the level of the RAS signal 406 is high while the levels of the CAS signal 405 and the WE signal 407 are low, the comparison circuit 51 makes a decision that write protection is not required, and operates that the WPACC signal 414 with the level turned to a high level (inactive) is output to the gate circuit 52 and the NMI signal 415 with the level turned to a high level (inactive) is output to the external bus interface 22.

If there is the write command (Yes in step 75), a bank and a column address are acquired from the BA signal 409 and the address signal respectively (step 76). Consequently, the comparison circuit 51 judges whether the address acquired in the steps 74 and 76 is in a write protection area, i.e. in the program area 41 shown in FIG. 3 or not (step 77). If the address is in the program area 41 (Yes in step 77), the comparison circuit 51 makes a decision that write protection is required, and makes the levels of the WPACC signal 414 output to the gate circuit 52 and the NMI signal 415 output to the external bus interface 22 low (active). If the address is not in the program area 41, that is, if the address is in the data area 42 (No in step 77), the comparison circuit 51 makes a decision that write protection is not required, and makes the levels of the WPACC signal 414 output to the gate circuit 52 and the NMI signal 415 output to the external bus interface 22 high (inactive).

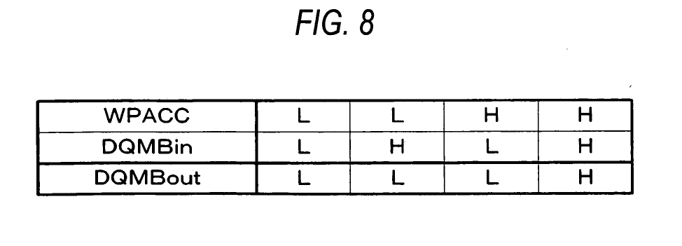

Next, processing in the gate circuit 52 will be described with reference to FIG. 8. The gate circuit 52 receives the DQMB signal 412 and the WPACC signal 414 from the SDRAM access state machine 23a and the comparison circuit respectively and sends the DQMB signal 412 to the SDRAM 40. In the following description, the DQMB signal 412 input from the SDRAM access state machine 23a to the gate circuit 52 is referred to as “DQMBin signal” and the DQMB signal 412 output from the gate circuit 52 to the SDRAM 40 is referred to as “DQMBout signal”. Incidentally, the DQMBin signal and the DQMBout signal make the same operations regardless of whether the subject is the upper 16 bits or the lower 16 bits.

FIG. 8 is a table showing the relation between the DQMBin signal/WPACC signal 414 input to the gate circuit 52 and the DQMBout signal output from the gate circuit 52.

When the level of the DQMBin signal is low (active) the level of the DQMBout signal is forcedly turned to a low level (active) because write protection is required. When the level of the DQMBin signal is high (inactive) write protection is not required. Accordingly, in this case, the DQMBout signal is controlled in accordance with control from the SDRAM access state machine 23a so that the level of the DQMBout signal is turned to a low level (active) when the level of the DQMBin signal is low (active), and that the level of the DQMBout signal is turned to a high level (inactive) when the level of the DQMBin signal is high (inactive).

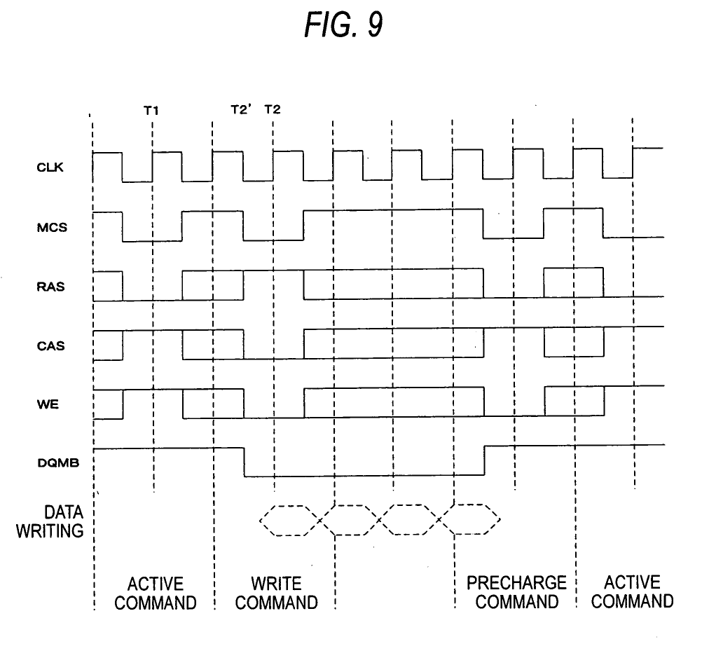

FIG. 9 is a timing chart showing an example of signals input to the SDRAM 40 in a write cycle in the case where write protection is executed by the gate circuit 52. Incidentally, in FIG. 9, the comparison circuit judges whether write protection is required or not, at the falling time T2′ of the CLK signal 410 just before the time T2 when a write command is input. The gate circuit controls the DQMB signal 412 on the basis of the judgment.

As shown in FIG. 9, the level of the DQMB signal 412 is turned to a low level (active) by the gate circuit 52 at the time T2 when the write command is input. Accordingly, input data is not written into the SDRAM 40.

As described above, in accordance with the embodiment, the comparison circuit 51 judges whether the write address is in the program area 41 or not. When a decision is made that writing is prohibited, the DQMB signal 412 of the gate circuit 52 is made active so that writing into the program area 41 can be suppressed. As a result, the operating program for controlling the CPU 20 can be restrained from being overwritten.

Moreover, writing into the SDRAM 40 is suppressed on the basis of the DQMB signal 412, not the WE signal 407. Accordingly, commands using the WE signal 407, the CAS signal 405 and the RAS signal 406 are not restrained from being input to the SDRAM 40.

Moreover, when data is to be written into the program area 41, the NMI signal 415 gives a notice to the CPU. Accordingly, program abnormality can be debugged.

According to the embodiment, the comparison circuit 51 and the gate circuit 52 control write protection based on the protection register 50 as to whether write protection is required or not. Accordingly, when the operating program is to be written into the program area 41, controlling can be made so that data is prohibited from being written into the program area 41 after the operating program is written normally.

Although the embodiment has shown the case where the telephone exchange 10 is used as an example. For example, the control apparatus of the embodiment may be applied to a general computer mounted with a CPU and an RAM or to a control board mounted with a control portion 14.

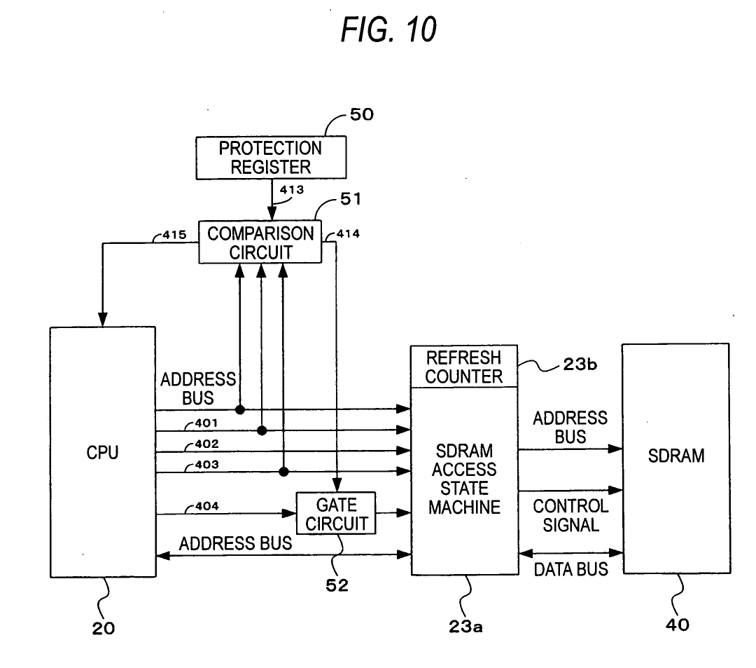

Although the embodiment has shown the case where the DRAM controller 23 is provided in the inside of the CPU 20, the control portion 14 may be configured so that the DRAM controller 23 is provided in the outside of the CPU 20. Also in the case where the DRAM controller 23 is provided in the outside of the CPU 20, the same control as in the embodiment may be performed between the DRAM controller 23 and the SDRAM 40 or processing may be made between the CPU 20 and the SDRAM access state machine. FIG. 10 is a diagram showing a specific example of a circuit concerned with the SDRAM 40 in the case where the SDRAM access state machine 23a and the refresh counter 23b are provided in the outside of the CPU 20 and in the case where write protection is performed between the CPU 20 and the SDRAM access state machine 23a.

In the example shown in FIG. 10, the address signal, the CS signal 401 and the WE signal 403 output from the CPU 20 are input to the comparison circuit 51. In this case, when the CS signal 401 and the WE signal 403 are active and the address signal indicates the address in the program area 41 of the SDRAM 40, the WPACC signal 414 is made active. The gate circuit 52 is put between BE signals 404. When the WPACC signal 414 is active, all the BE signals 404 (all 4 bits in the case where the CPU 20 processes data for every date length of 32 bits) to be output are made active. When the WPACC signal is inactive, the BE signal 404 output from the CPU 20 is directly sent to the SDRAM access state machine 23a. As a result, the same effect as in the embodiment can be obtained.

According to the above-embodiments, there can be provided a control apparatus in which RAM control commands are not restrained from being input while a wrong operation of the CPU is prevented from being caused by the rewriting of the operating program in the RAM.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

What is claimed is:

1. A control apparatus comprising:
a RAM capable of rewriting data;
a data writing unit that writes a predetermined length of data output to the RAM in an arbitrary area of the RAM on the basis of an address signal for designating an address of the RAM and an effective area definition signal for defining an area effective in writing the predetermined length of data into the RAM;
a judgment unit that judges whether the writing of the predetermined length of data into the RAM by the data writing unit is to be prohibited or not; and
a rewriting prohibition unit that changes the effective area definition signal to a signal invalidating the writing of the whole predetermined length of data when the judgment unit makes a decision that the writing is to be prohibited.

2. A control apparatus according to claim 1, wherein the judgment unit makes a decision that the writing of the predetermined length of data into the RAM by the data writing unit is to be prohibited when the address is in an unrewritable area of the RAM.

3. A control apparatus according to claim 2, wherein a program executed by the data writing unit is stored in the unrewritable area.

4. A control apparatus according to claim 1, wherein the judgment unit sends a notice signal for giving a notice of the prohibition of the writing of the predetermined length of data to the data writing unit when the judgment unit makes a decision that the writing of the determined length of data into the RAM is to be prohibited.

5. A control apparatus according to claim 1, further comprising:
a write protection setting unit that switches whether the judgment unit makes a decision or not.

6. A control apparatus according to claim 1, wherein the control apparatus is a telephone exchange.

7. A controlling method comprising:
writing a predetermined length of data output to an RAM capable of rewriting data in an arbitrary area of the RAM on the basis of an address signal for designating an address of the RAM and an effective area definition signal for defining an area effective in writing the predetermined length of data into the RAM;
judging whether the writing of the predetermined length of data into the RAM is to be prohibited or not; and
changing the effective area definition signal to a signal invalidating the writing of the whole predetermined length of data when a decision is made that the writing is to be prohibited.

8. A storage medium readable by a computer, the storage medium storing a program of instructions executable by the computer to perform a function, the function, comprising:
writing a predetermined length of data output to an RAM capable of rewriting data in an arbitrary area of the RAM on the basis of an address signal for designating an address of the RAM and an effective area definition signal for defining an area effective in writing the predetermined length of data into the RAM;
judging whether the writing of the predetermined length of data into the RAM is to be prohibited or not; and
changing the effective area definition signal to a signal invalidating the writing of the whole predetermined length of data when a decision is made that the writing is to be prohibited.
